(19) United States
(12) Patent Application Publication
(10) Pub. No.: US 2006/0215897 A1
(43) Pub. Date: Sep. 28, 2006

(54) Medical image display apparatus

(76) Inventor: Takanori Ando, Tokyo (JP)

Correspondence Address: CANTOR COLBURN, LLP, 55 GRIFFIN ROAD SOUTH, BLOOMFIELD, CT, 06002, US

(21) Appl. No.: 11/376,040

(22) Filed: Mar. 15, 2006

(30) Foreign Application Priority Data
Mar. 22, 2005 (JP) 2005-081756

(51) Int. Cl. G06K 9/00

(52) U.S. Cl. 382/132

(57) ABSTRACT

A medical image display apparatus including: a display unit for displaying medical images for a radiogram interpretation; an operation unit for inputting setting information of the medical images to be displayed at a time of a conference and a layout of the medical images; a storage unit for storing the setting information of the medical images and the layout of the medical images, the setting information input through the operation unit, as conference information; and a display control unit for displaying the medical images to be displayed in the set layout on the display unit in accordance with the stored conference information at the time of the conference.

### BACKGROUND OF THE INVENTION

1. Field of the Invention

The present invention relates to a medical image display apparatus that displays a medical image.

2. Description of Related Art

A doctor sometimes uses medical images obtained by examination radiographing not for a radiogram interpretation, but for a conference (explanation) such as a lecture or an explanatory meeting. In this case, medical images necessary for the explanation, such as the medical images showing a case of a disease, are arranged on a radiogram interpretation screen of a medical image display apparatus. Conventional medical image display apparatus require a lot of time and troubles for switching images for the conference. Moreover, even if a file for exclusive use of the conference is created, preparations such as selecting the medical images necessary for the conference, setting an order of arrangement, setting arrangement positions, and the like are needed. Such operations are troublesome and need a long time for a doctor.

A conventional method of storing the state that has been once displayed together with the displayed materials to display the materials in the displayed state at the last time when the materials are again read has been disclosed. For example, refer to JP Tokukai-hei-5-67160A.

However, when the method disclosed in the Patent Document 1 is applied, not only at the time of a conference but also at the time of practicing a business such as an ordinary radiogram interpretation, a diagnosis and the like, medical images are displayed in the layout of the display at the last time. The observation styles of medical images at the time of a radiogram interpretation and at the time of a conference differ from each other, and the layout of the medical images at the time of the conference is not suitable for the layout of the medical images at the time of the radiogram interpretation.

When the number of times of conferences becomes large, the layout of the display at the last time frequently becomes impossible to be known, and the layout cannot be ascertained unless it is once displayed.

The number of image sheets of the medical images generated by computed tomography (CT), magnetic resonance imaging (MRI) or the like is very large by the unit of 100 sheets, and consequently the retrieval of the medical images used for a conference from the innumerable medical images is a large work load for a doctor.

Further, a medical image display apparatus used for a radiogram interpretation is frequently provided with a plurality of monitors used for the radiogram interpretation and for a comparison. However, because a display apparatus other than the medical image display apparatus used for an ordinary radiogram interpretation is sometimes used at a conference, display environments at the time of the radiogram interpretation and at the time of the conference sometimes differ from each other. When the display in the same layout as that at the last time is equally carried out even in such a case, it becomes impossible to display medical images as a doctor wishes because the display environments do not agree.

### SUMMARY OF THE INVENTION

It is an object of the present invention to provide a medical image display apparatus capable of carrying out a setting and a display for a conference easily.

In order to achieve the object, in accordance with a first aspect of the present invention, the medical image display apparatus comprises: a display unit for displaying medical images for a radiogram interpretation; an operation unit for inputting setting information of the medical images to be displayed at a time of a conference and a layout of the medical images; a storage unit for storing the setting information of the medical images and the layout of the medical images, the setting information input through the operation unit, as conference information; and a display control unit for displaying the medical images to be displayed in the set layout on the display unit in accordance with the stored conference information at the time of the conference.

According to the medical image display apparatus of the first aspect of the invention, the medical images to be displayed at a conference and the layout of the medical images are previously set, and the conference information is read at the conference. Thereby, the set medical images can be easily displayed in the set layout. Consequently, the operations such as the retrieval of the medical images of display objects, and the settings of display positions can be omitted at the time of the conference, and the working efficiency of a doctor can be improved.

Preferably, the display control unit generates reduced images of the set medical images, the reduced images arranged in the set layout in accordance with the stored conference information, and the display control unit displays the generated reduced images on the display unit.

According to such a medical image display apparatus, because the layout at the time of a conference is displayed with reduced images, a doctor can previously ascertain the set medical images and the layout of the medical images. Because the medical images are displayed as the reduced images, the doctor can ascertain the contents of the conference information in a short time without opening the screen for a conference one by one.

Preferably, the display unit displays a setting screen for setting the layout of the medical images to be displayed at the time of the conference according to a display environment at the time of the conference, and the operation unit can be used for inputting the setting information of the medical images to be displayed at the time of the conference and the layout of the medical images on the setting screen.

According to such a medical image display apparatus, it is possible to set the medical images to be displayed and the display number of the medical images to each of the monitors with a setting screen according to the display environment, for example, the number of the monitors, monitor sizes and the like, at the time of a conference. Thereby, even when the display environments at the time of a setting of conference information and at the time of the conference differ from each other, at the time of the conference the medical images can be displayed in the same display form as that which the doctor intended at the time of the setting.

Preferably, when a medical image displayed on the display unit for a radiogram interpretation is subjected to a moving operation onto the setting screen with the operation unit, setting information indicating the setting of the medical image subjected to the moving operation as a medical image for the conference is stored in the storage unit.

According to such a medical image display apparatus, when a moving operation of a medical image displayed for a radiogram interpretation to the setting screen is carried out, the medical image is set as a medical image that should be displayed at the time of a conference. Consequently, when a medical image that is required to be used for a conference at the time of a radiogram interpretation is displayed, the medical image can be easily set as a medical image for a conference with the easy operation of the moving operation. Therefore, the working efficiency of a doctor can be more improved.

### BRIEF DESCRIPTION OF THE DRAWINGS

FIG. 1 is a diagram showing the internal configuration of a medical image display apparatus in an embodiment;

FIG. 2 is a diagram showing an example of the data configuration of a conference file;

FIG. 3 is a view showing an example of conference menu buttons provided on a screen;

FIG. 4 is a flowchart illustrating file creation processing executed by the medical image display apparatus;

FIGS. 5A and 5B are views showing an example of a setting screen for setting medical images for a conference and the display conditions of the medical images;

FIG. 6 is a flowchart illustrating conference display processing executed by the medical image display apparatus;

FIG. 7A is a view showing an example of a list display of a conference file, and FIG. 7B is a view showing examples of reduced images of a layout by a conference file; and

FIG. 8 is a view showing examples of conference screens displayed by the conference file.

### DETAILED DESCRIPTION OF THE PREFERRED EMBODIMENTS

Hereinafter, a medical image display apparatus according to preferred embodiments of the invention will be described with reference to the drawings.

First, a configuration is described.

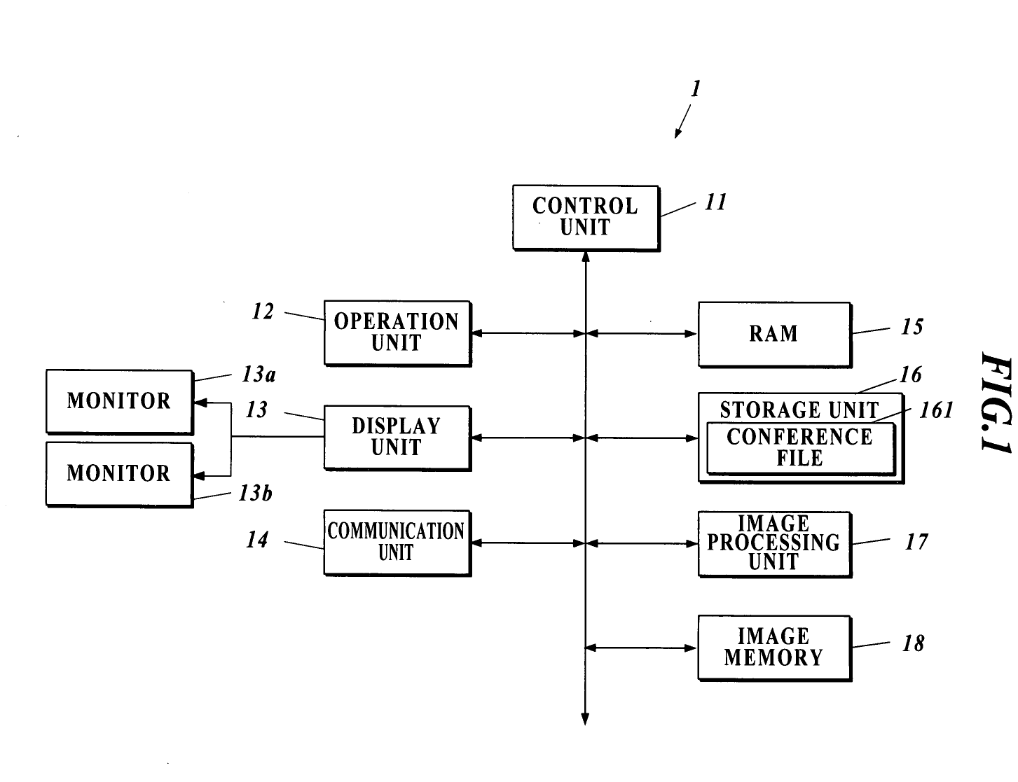

FIG. 1 shows the internal configuration of a medical image display apparatus 1 in an embodiment.

As shown in FIG. 1, the medical image display apparatus 1 is composed of a control unit 11, an operation unit 12, a display unit 13 including monitors 13a and 13b, a communication unit 14, a RAM 15, a storage unit 16, an image processing unit 17 and an image memory 18.

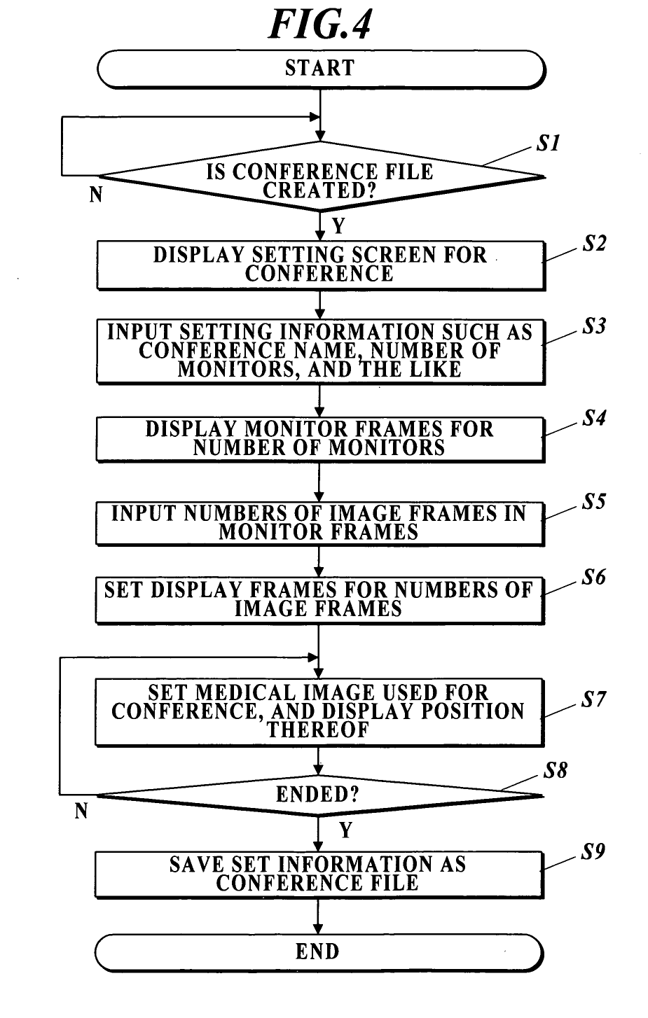

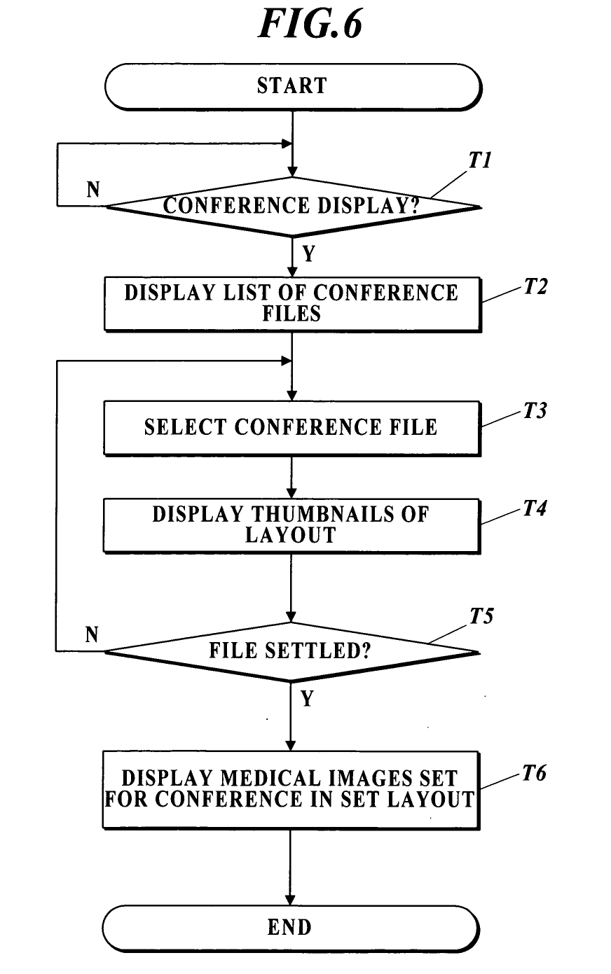

The control unit 11 is composed of a central processing unit (CPU) and the like. The control unit 11 reads various control programs according to the invention, such as a file creation processing program (see FIG. 4), a conference display processing program (see FIG. 6) and the like, from the storage unit 16. The control unit 11 executes various operations in conformity with the read programs, and wholly controls the execution of the processing (the contents of the processing will be described later).

The operation unit 12 is composed of a keyboard, a mouse and the like, and generates an operation signal corresponding to a key operation or a mouse operation to output the generated operation signal to the control unit 11.

The display unit 13 is provided with the monitors 13a and 13b, each made of a liquid crystal display (LCD) or the like, and makes the monitors 13a and 13b display various display screens such as an operation screen, medical images and the like thereon.

The communication unit 14 is provided with communication interfaces such as a router, a modem and the like, and performs transmission and reception of various kinds of data with external apparatus connected through communication networks in conformity with instructions from the control unit 11. For example, the communication unit 14 is connected with an image server storing medical images to receive medical images, which are display objects, or transmits processed images subjected to image processing to the external apparatus such as a management server, a film output apparatus and the like.

The RAM 15 is a working memory for saving data temporarily, and stores data, processing results and the like of programs that have been expanded by the control unit 11.

The storage unit 16 stores the various control programs mentioned above, various parameters necessary for execution of programs, processing results and the like.

The storage unit 16 stores conference files 161. The conference files 161 mean conference information for setting the medical images to be displayed at the times of conferences and the layouts of the medical images.

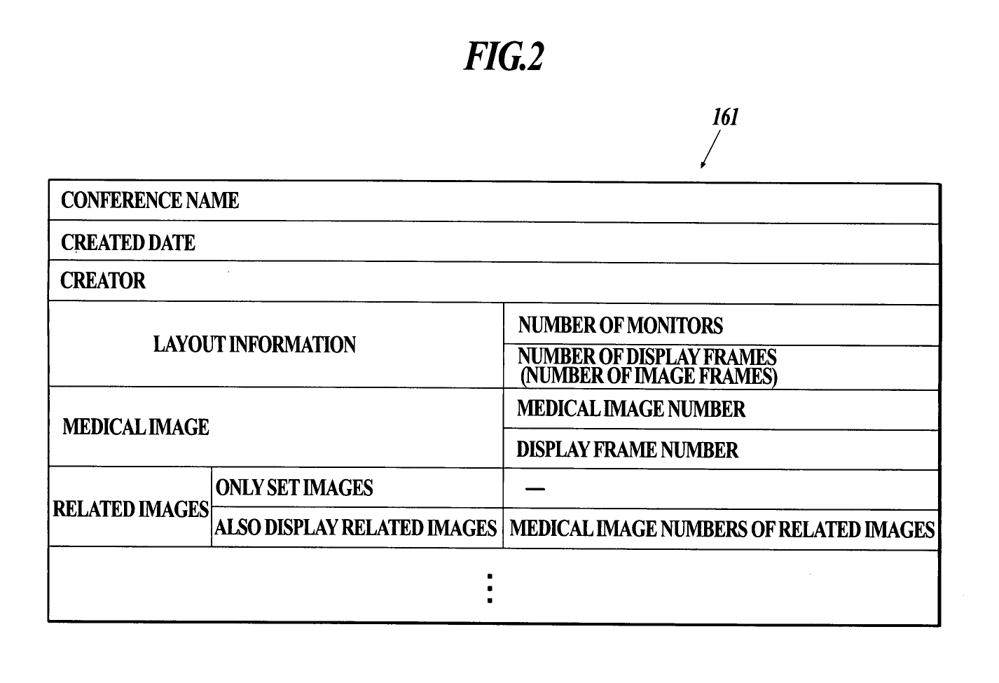

Each of the conference files 161, as shown in FIG. 2, stores various kinds of setting information such as a conference name, a created date, a creator, the number of monitors used for the conference, layout information such as the number of display frames (the number of image frames) to be displayed on a monitor and the like, the medical image number of a medical image to be displayed (or an image file name), the display frame number in which the medical image is displayed, the display conditions of related images (a series of medical images in the same examination, medical images in related examinations and the like) related to the medical image. In addition, as the display condition of the related images, a selected condition of either the display of only the medical images set to be used for the conference or the display of the medical images including the related images also is set. In case of the setting of displaying the related images also, the medical image numbers of the related images are also stored.

The image processing unit 17 processes necessary image processing to medical images. As the image processing, for example, the reduction/expansion processing, the gradation conversion processing, the sharpness adjustment processing, the dynamic range compression processing and the like of the medical images can be cited.

The image memory 18 is a memory for saving the medical images that are display objects. A medical image is accompanied by the patient information (the information pertaining to the radiographed patient of the medical image), the examination information (the information pertaining to the examination), the series information (information pertaining to a series of radiographing in the same examination), the image detail information (the information pertaining to the generated medical image, which information includes the information on the medical image number for individually identifying the medical image) pertaining to the medical image at the time of the generation thereof. The image memory 18 manages each image based on the accompanied information.

Next, the operation is described.

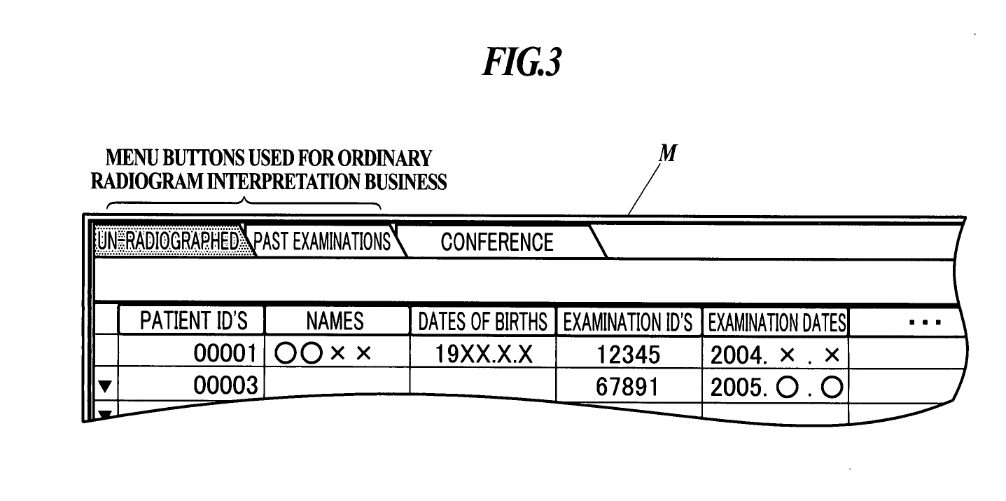

In an operation screen displayed in the medical image display apparatus 1 at the time of a radiogram interpretation, as shown in FIG. 3, in addition to various menu buttons used for an ordinary radiogram interpretation business, a conference menu button M for a conference operation is displayed. When the conference menu button M receives a depression operation, a menu for creating a conference file and a menu for displaying a medical image based on the created conference file are selectively displayed as a conference menu. Then, when the creation menu of the conference file is selected, the file creation processing shown in FIG. 4 is started. When the display based on the conference file is selected, the conference display processing, which will be described later, is started.

First, a description is given to the case where the creation menu of a conference file is selected.

FIG. 4 is a flowchart illustrating the file creation processing executed by the medical image display apparatus 1 when a display setting for a conference is carried out.

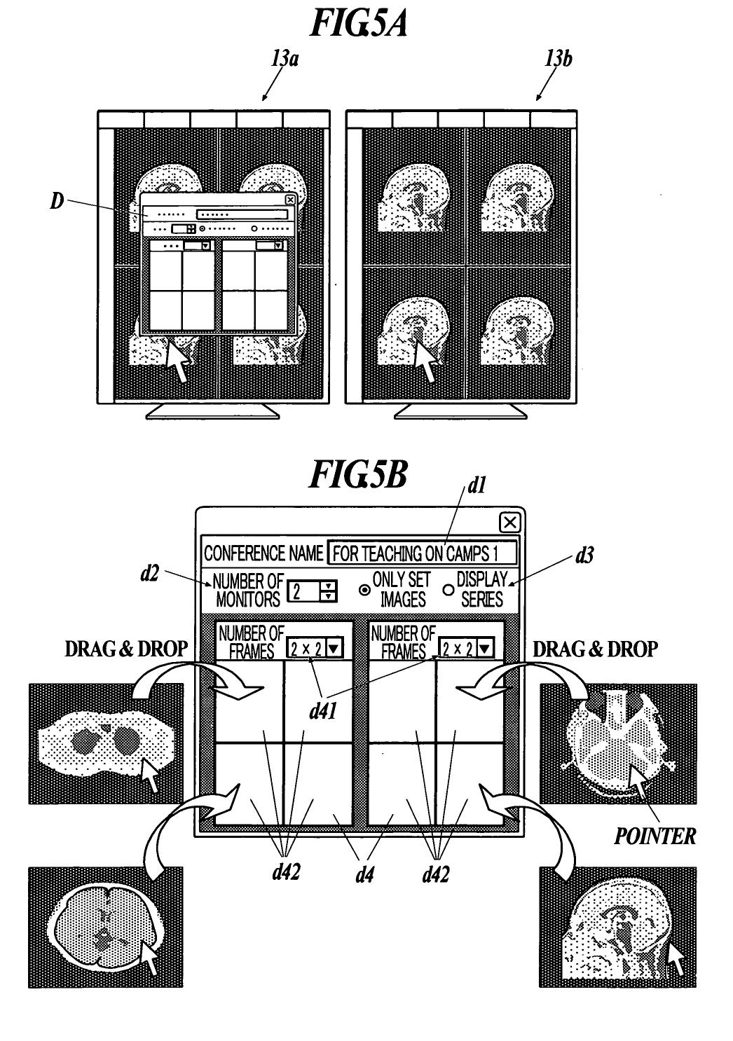

In the file creation processing shown in FIG. 4, when the creation of a conference file is selected (step S1; Y), as shown in FIG. 5A, a setting screen D for a conference is displayed on the radiogram interpretation screen of a monitor 13a (step S2). As shown in FIG. 5B, the setting screen D is provided with input regions d1 and d2 for inputting a conference name and the setting information of the number of monitors, respectively, together with a selection region d3 for selecting either a display of only set images or a display of a series of related images pertaining to the set images.

A doctor inputs the name of the conference into the input region d1 with the operation unit 12, and inputs the number of the monitors used at the time of the conference into the input region d2. Moreover, when only the medical images set here are displayed at the conference, the doctor selects the item “only set images” in the selection region d3. When also the related images pertaining to the set medical images are displayed together with the set medical images, the doctor selects the item “display series.”

When the conference name and the number of monitors are input (step S3), as shown in FIG. 5B, the medical image display apparatus 1 displays monitor frames d4 for setting the medical images for the conference for the input number of the monitors (step S4). The monitor frames d4 are provided with input regions d41 of the setting information on the number of image frames to be displayed on the monitors. Moreover, the selection information in the selection region d3 is stored in the RAM 15 as the setting information of the related images.

The doctor inputs the setting information on the numbers of the image frames that the doctor wants to display on each of the monitors into the input regions d41 with the operation unit 12.

In the medical image display apparatus 1, when the setting information on the numbers of the image frames is input through the operation unit 12 (step S5), the control unit 11 stores the input numbers of the image frames into the RAM 15, and sets the numbers of the image frames. Then, the control unit 11 carries on the display control to divide the regions in the monitor frames d4 according to the set numbers of the image frames, and consequently a plurality of display frames d42 for displaying the medical images therein are formed (step S6).

The doctor can carry out a setting operation of the medical images to be used for the conference with the operation unit 12, and can carry out the setting operation of the display positions of the medical images. To put it concretely, as shown in FIG. 5B, the doctor operates the pointer with the mouse, and carries out the drag operation of a medical image to be used in the conference between the medical images displayed on the radiogram interpretation screen to carry out the drop operation of the dragged medical image into one of the display frames d42 in which the doctor wants to display the medical image. Thereby, in the medical image display apparatus 1, the medical image subjected to the drag operation by the pointer is moved into the display frame d42 the drag operation into which the medical image has received to be displayed therein (step S7). At this time, the medical image number and the display frame number of the display frame the moving operation into which the medical image has been subjected to are stored into the RAM 15 as the setting information of the medical image that should be displayed at the time of the conference and the display position of the medical image, respectively. In addition, the medical image display apparatus 1 may be configured so that medical images can be selected not from the radiogram interpretation screen but from a patient list screen or the like.

The settings of the medical images and the display positions described above are repeated until the settings of all of the medical images to be used in the conference have ended. When the settings of all of the medical images have ended (step S8; Y), each setting information stored in the RAM 15 is saved in the storage unit 16 as a conference file (step S9).

Next, a description is given to the conference display processing executed in the medical image display apparatus 1 when a menu for carrying out a display based on a saved conference file is selected.

FIG. 6 is a flowchart illustrating the conference display processing.

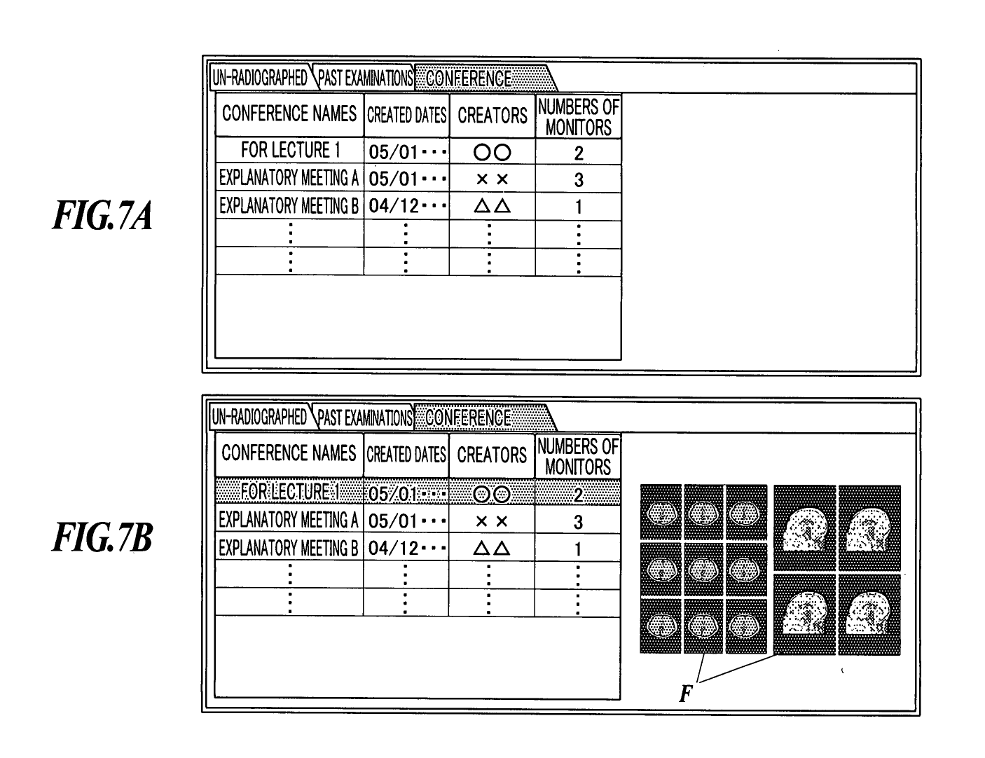

In the conference display processing shown in FIG. 6, when a display based on the conference file is selected (step T1; Y), the conference files that have been already created are read from the storage unit 16, and, as shown in FIG. 7A, the read conference files are listed to be displayed on the monitor 13a in the form of a list display (step T2). In the example shown in FIG. 7A, various kinds of setting information such as a conference name, a created date of the conference file, a creator, the number of monitors, and the like are displayed for each of the read conference files.

The doctor can select a desired conference file between the displayed conference files as the list.

In the medical image display apparatus 1, when a conference file is selected with the operation unit 12 (step T3), the control unit 11 and the image processing unit 17 generate reduced images of the medical images set for the conference which reduced images are arranged in a layout in the set display frames of the set monitor frame in conformity with the setting information of the conference file. The reduced images are displayed on the monitor 13a as shown in FIG. 7B (step T4).

The doctor observes the reduced images F as shown in FIG. 7B. When the doctor thinks that the conference file is satisfactory, the doctor carries out an instruction operation of settling with the operation unit 12. When the doctor wants to refer to another conference file, the doctor carries out another selection operation of the desired conference file from the list display of the conference files.

In case of carrying out the selection operation of the other conference file with the operation unit 12 (step T5; N), the medical image display apparatus 1 returns its processing to the processing at the step T3 to repeat the display of the reduced images of a selected conference file.

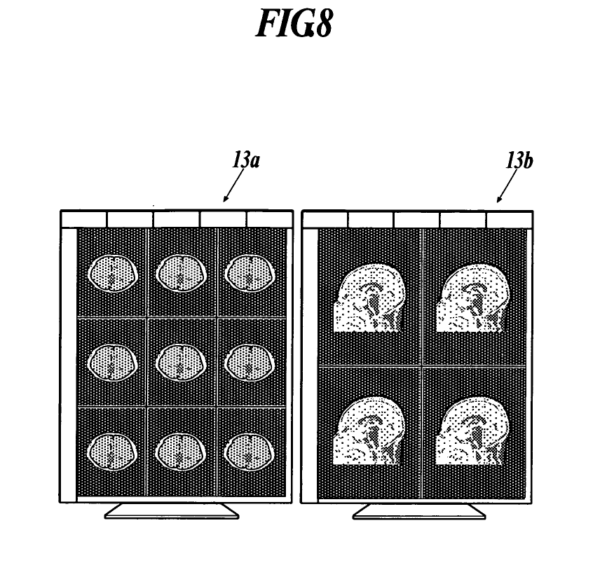

On the other hand, when the settling of the conference file is instructed with the operation unit 12 (step T5; Y), conference screens are displayed on the monitors 13a and 13b as shown in FIG. 8, and the medical images set for the conference are displayed in the layout in which the medical images are arranged at set display positions (in the display frames of the monitor frames) in conformity with the setting information of the settled conference file (step T6). That is, the full screen display is carried on in the same layout as that of the reduced images. In addition, when the display of related images is set based on the conference file, the image display apparatus 1 is configured to be able to switch the medical images which are being displayed to the related images on the conference screens.

As described above, according to the embodiment, the conference files regulating the medical images to be displayed at the time of a conference and the layout of the medical images are previously created, and the conference file is read at the time of the conference to enable the easy display of the set medical images under the set display conditions. Consequently, it is unnecessary to carry out both of the operation of selecting the medical images and the operation of the setting of the display positions of the medical images at the time of the conference, and the work load of a doctor can be reduced. Moreover, because a menu for a conference is prepared besides a menu for an ordinary radiogram interpretation operation, the operations of a doctor can be separated, and the operation can be improved in its efficiency.

Further, because a setting screen provided with the monitor frames, the display frames and the like is displayed according to a display environment, such as the number of the monitors, at the time of a conference, the layout according to the display environment at the conference can be set. Consequently, a doctor can display the medical images as the doctor intends at the time of the conference. Moreover, because the medical images displayed on a radiogram interpretation screen can be set as the medical images for the conference by carrying out the drag and drop operations onto the setting screen of the conference, the settings of the medical images can be easily carried out by simple operations. Although the number of medical images is large in CT or MRI, the medical images which the doctor wants to use at the time of the conference while the doctor is carrying out a radiogram interpretation can be set for the conference with simple operations by the method described above, and consequently working efficiency is good.

Furthermore, because the reduced images in the layout set by a conference file are displayed, it can be possible to ascertain the layout based on the created conference file previously to a conference.

In addition, the medical image display apparatus 1 in the present embodiment is a suitable example to which the present invention is applied, and the present invention is not limited to the embodiment.

For example, although in the present embodiment the descriptions have been given to the example in which the same medical image display apparatus 1 creates a conference file setting the medical images and the layout of the medical images at a conference and carries out the display of the medical images using the conference file, the present invention is not limited to such an example. The created conference file may be read with another medical image display apparatus, and the display of the medical images for a conference may be performed of the other medical image display apparatus. In this case, even in the case where the medical image display apparatus 1 that has created the conference file and the medical image display apparatus to be used at the conference are different from each other, the display of the medical images can be performed in the layout which the doctor has intended.

The entire disclosure of Japanese Patent Application No. 2005-81756 which was filed on Mar. 22, 2005, including specification, claims, drawings and abstract, is incorporated into the present invention in its entirety.

What is claimed is:

1. A medical image display apparatus comprising:
a display unit for displaying medical images for a radiogram interpretation;
an operation unit for inputting setting information of the medical images to be displayed at a time of a conference and a layout of the medical images;
a storage unit for storing the setting information of the medical images and the layout of the medical images, the setting information input through the operation unit, as conference information; and
a display control unit for displaying the medical images to be displayed in the set layout on the display unit in accordance with the stored conference information at the time of the conference.

2. The medical image display apparatus of claim 1, wherein the display control unit generates reduced images of the set medical images, the reduced images arranged in the set layout in accordance with the stored conference information, and the display control unit displays the generated reduced images on the display unit.

3. The medical image display apparatus of claim 1, wherein the display unit displays a setting screen for setting the layout of the medical images to be displayed at the time of the conference according to a display environment at the time of the conference, and the operation unit can be used for inputting the setting information of the medical images to be displayed at the time of the conference and the layout of the medical images on the setting screen.

4. The medical image display apparatus of claim 3, wherein when a medical image displayed on the display unit for a radiogram interpretation is subjected to a moving operation onto the setting screen with the operation unit, setting information indicating the setting of the medical image subjected to the moving operation as a medical image for the conference is stored in the storage unit.
